(19) United States
(12) Patent Application Publication
(10) Pub. No.: US 2026/0292753 A1
(43) Pub. Date: Sep. 24, 2026

(54) DEREGISTRATION OF INACTIVE WTRU OF AI/ML NETWORK SLICE

(71) Applicant: INTERDIGITAL PATENT HOLDINGS, INC., Wilmington, DE (US)

(72) Inventors: Achref Methenni, Montreal (CA); Ulises Olvera-Hernandez, Saint-Lazare (CA); Samir Ferdi, Kirkland (CA); Jung Je Son, Warrington, PA (US)

(73) Assignee: INTERDIGITAL PATENT HOLDINGS, INC., Wilmington, DE (US)

(21) Appl. No.: 19/473,037

(22) PCT Filed: Apr. 5, 2024
(86) PCT No.: PCT/US2024/023346

§ 371 Date: Oct. 6, 2025

Related U.S. Application Data
(60) Provisional application No. 63/494,674, filed on Apr. 6, 2023.

(51) Int. Cl. H04W 60/06; H04L 41/16; H04L 65/1073

(52) U.S. Cl. CPC H04W 60/06; H04L 41/16; H04L 65/1073

(57) ABSTRACT

A network slice admission control function (NSACF) is triggered to check an artificial intelligence machine learning (AIML) network slice capacity when a wireless transmit receive unit (WTRU) wants to register for the slice. When the NSACF determines that the slice reaches is WTRU registrations capacity, WTRUs which are not active in the AIML slice may be identified as eligible to be deregistered from the slice. The NSACF receives assistance form a policy control function (PCF) and, via a network exposure function, an application function (AF) to confirm the deregistration of an eligible registered WTRU, in favor of admitting another WTRU to the slice. Embodiments also include the NSCAF using estimation of capacity of the AIML slice from a network data analytics function (NWDAF) for potential deregistration of WTRUs prior to reaching AIML maximum capacity. Additional embodiments are disclosed.

### CROSS-REFERENCE TO RELATED APPLICATIONS

This application claims the benefit of U.S. Provisional Application No. 63/494,647, filed Apr. 6, 2023, the contents of which are incorporated herein by reference.

### BACKGROUND

Artificial intelligence machine learning (AIML) is being increasingly utilized in wireless communications such as WiFi and cellular networks. Network slicing is a configuration allowing multiplexing of virtualized and independent logical networks to be created on top of a common physical infrastructure. For example, a slice may include dedicated radio, transport and core resources including a dedicated user plane function (UPF). 5G core networking has to support multiple network slices and differentiate between them according to the characteristics of the slices. Signaling, such as single network slice selection assistance information (S-NSSAI) may be used to identify a network slice across core, radio access network (RAN) and user equipment components. AIML applications may be included in a slice.

Consider a scenario where a group of client devices, such as wireless transmit receive units (WTRUs) have been using an AIML application for a certain AIML operation such as Federated Learning (FL). In a first scenario, the WTRUs are using the same AIML application. Some of these WTRUs are actively exchanging the AIML traffic, whereas other WTRUs may not be using the AIML application or are inactive in some way. These WTRUs may be registered in the same AIML slice since the application for AIML operation is being served by a single slice.

When the number of registered WTRUs causes a maximum level of slice capacity to be reached, the slice cannot admit new WTRUs until the number of registered WTRUs decreases. In the example scenario, a new WTRU potentially wants to participate in the Federated Learning application and eventually exchange AIML traffic for this application in the slice. Enhancements for 5G system (5GS) slice admission for the AIML operations are desired to allow WTRUs who want to actively use the AIML application when the capacity of the AIML slice is reached, to allow for a better AIML application performance.

### SUMMARY

According to certain aspects of the disclosed embodiments, a network slice admission control function (NSACF) is triggered to check an artificial intelligence machine learning (AIML) network slice capacity when a wireless transmit receive unit (WTRU) wants to register for the slice. When the NSACF determines that the slice has reached a threshold capacity of WTRU registrations, WTRUs which are not active in the AIML slice may be identified as eligible to be deregistered from the slice. In one aspect, the NSACF receives assistance form a policy control function (PCF) and, via a network exposure function, an application function (AF) to confirm/allow the deregistration of an eligible registered WTRU, in favor of admitting another WTRU to the slice.

In one aspect, the NSACF polls a session managment function (SMF) and/or a user plane function (UPF) to determine WTRUs registered with the slice may be eligible for deregistation based on whether whether: (i) an active AIML packet data unit (PDU) session, or (ii) any PDU sessions have occurred with a registered WTRU within a threshold window of time.

When at least one WTRU registered to the slice is determined to be eligible and confirmed allowed for deregistration, the NSACF may message an access and mobility management function (AMF) to deregister the WTRU from the AIML network slice. The NSACF may further message the AMF to admit a new WTRU for AIML slice registration and use.

In another aspect, if the AIML slice has not yet reached its WTRU capacity, but for example, may have reached a certain threshold below capacity, the NSACF may request expected slice capacity predictions from a network data analytics function (NWDAF) to determine if one or more WTRUs should be deregistered from the slice. When the NSACF determines at least one WTRU is eligible and allowed to be deregistered, it forwards this information to the AMF to deregister the WTRU from the slice. Additional features and aspects are disclosed in the embodiments that follow.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram showing a scenario of an AIML slice with full capacity of registered WTRUs and a new WTRU attempting to join;

FIG. 3 is a network sequence diagram showing a method for WTRU AIML Slice deregistration including assistance from a policy control function (PCF) and an application function (AF), according to one embodiment;

FIG. 4 is a network sequence diagram showing a method for WTRU AIML slice deregistration for a slice serving multiple application server providers (ASPs) with PCF assistance, according to an embodiment;

FIG. 5 is a network sequence diagram showing a method for WTRU AIML slice deregistration assisted with expected slice capacity predictions according to one embodiment; and

FIG. 6 is a flow diagram detailing a method for a network node including a network slice admission control function (NSACF) according to an embodiment.

### DETAILED DESCRIPTION

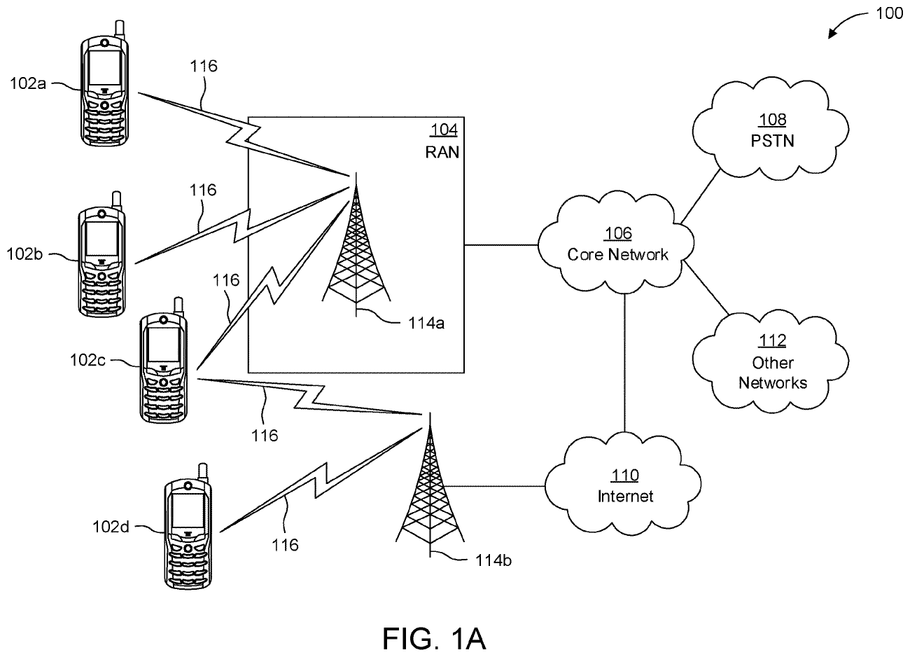

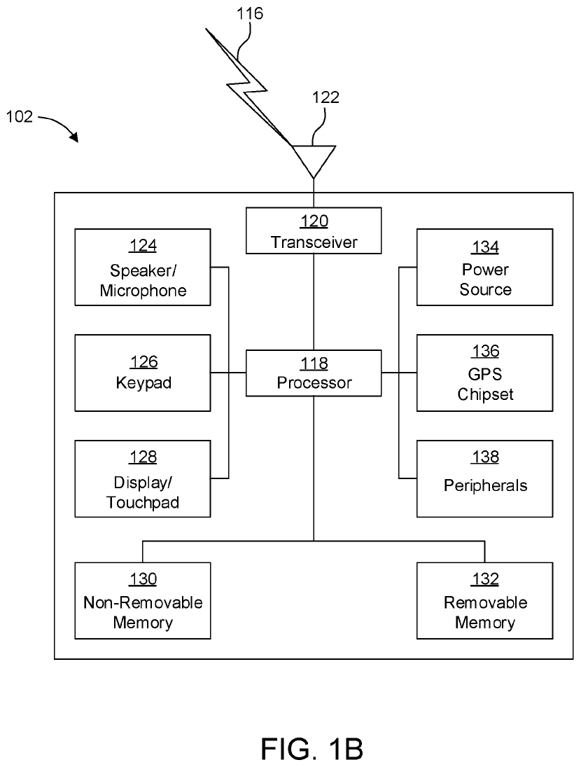

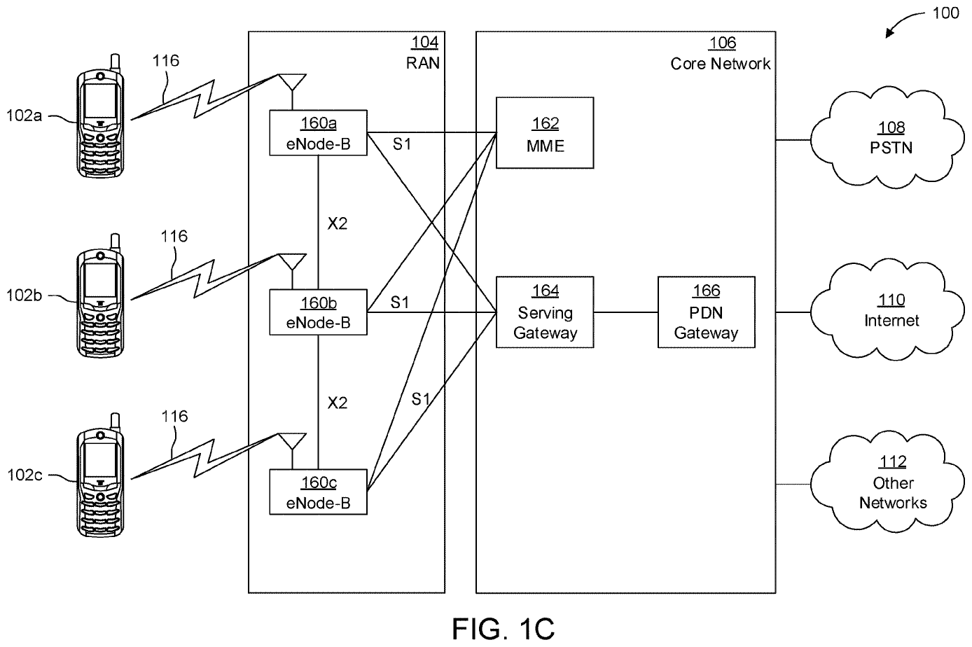

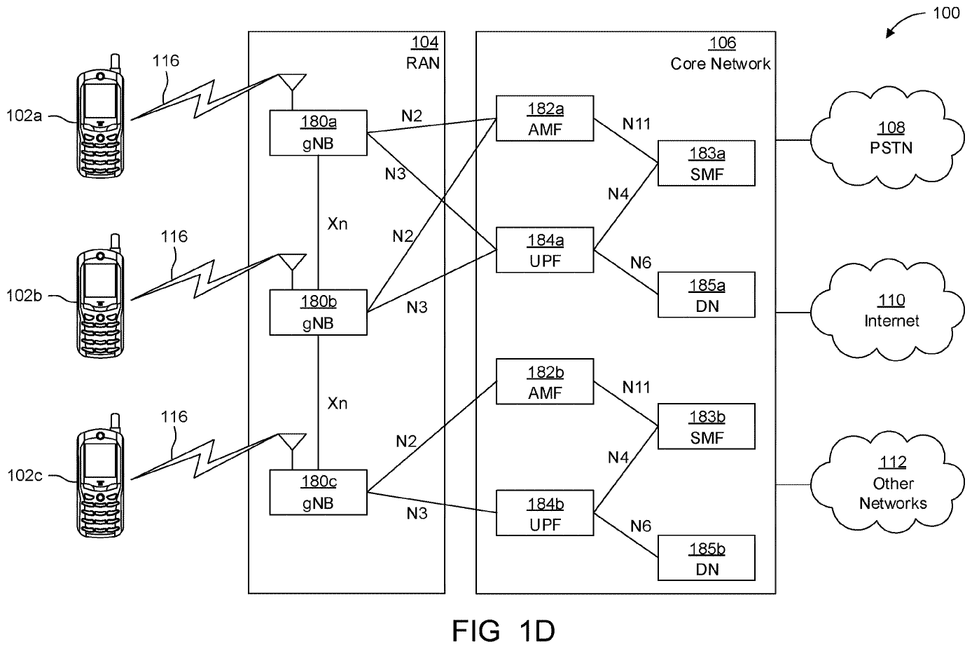

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR. In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUS 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments for WTRU deregistration from AIML slice when the slice reaches its capacity of WTRU slice registrations using a network slice admission control function (NSACF) are now described.

In various embodiments the NSACF is utilized for WTRU deregistration as described further. It should be recognized that the following description is merely an illustrative example and various features or actions may be performed by other functions or combinations of functions. Further, the functions described are logical entities resident at one or more network nodes and as such, may be incorporated in one or more programs operating at the same, or different physical locations, such as residing on one or more network servers. Initially, the NSACF receives a request from an access management mobility function (AMF) to check the slice availability for a second WTRU, after the second WTRU requested to register with an AIML single network slice selection assistance information (S-NSSAI). The NSACF detects that the slice capacity for the requested slice is reached in terms of existing WTRU registrations.

Next, the NSACF determines that a first WTRU, already registered with the AIML S-NSSAI is eligible to be deregistered from the AIML slice. This can be detected by the NSACF using information such as: (i) the first WTRU has no active PDU sessions in this slice: even though WTRU1 is registered to the AIML slice, it does not have any PDU session; and/or (ii) the first WTRU has a PDU session with the slice, but WTRU1 has no active AIML traffic that is being exchanged between WTRU1 and the AIML application function (AF) and routed via the user plane function (UPF).

The NSACF may send a request to the policy control function (PCF) if there are policies regarding WTRU deregistration or other parameters. In one embodiment, the NSACF receives related information from the PCF including, for example, PCF determination/assistance information regarding WTRU1 deregistration.

The NSACF may further perform an application function (AF) check by communicating with the application function whether a change in the configuration of WTRUs for the considered AIML application is permitted/plausible/desired. The NSACF may receive confirmation/authorization information from the AF, for example, via the network exposure function (NEF), about the new configuration (e.g., deregistering the first WTRU form the AIML slice to allow the second WTRU to be registered).

When confirmation is received from the application function, the NSACF authorizes the information from the AF and determines that WTRU1 is to be deregistered form the network slice. Next, the NSACF sends a message to the AMF to deregister the first WTRU from the AIML single network slice selection assistance information (S-NSSAI) to allow the second WTRU to register for the AIML S-NSSAI. In this manner, AIML slice resources may be more efficiently utilized.

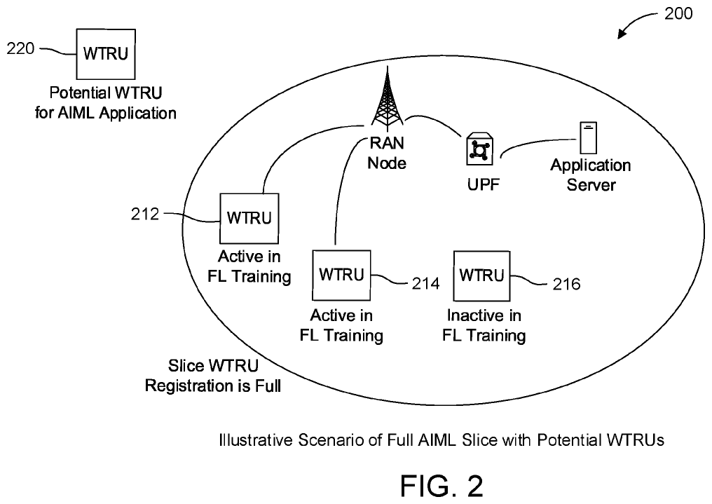

Referring to FIG. 2, a network diagram 200 is shown where the NSACF may be applied to the scenario previously mentioned, i.e., where a group of WTRUs, 212, 214 and 216, have been using an AIML application for a certain AIML operation such as Federated Learning. As shown, some of the WTRUs 212, 214 are actively exchanging the AIML traffic, whereas other WTRUs 216 may not be using the AIML application or are otherwise inactive in some way. When the number of registered WTRUs causes a maximum level of slice capacity to be reached, the slice cannot otherwise admit new WTRUs, e.g., WTRU 220, until the number of registered WTRUs decreases. The embodiments using the NSACF may enable a new WTRU 220 to participate in the Federated Learning application and eventually exchange AIML traffic for this application in the slice.

Embodiments for fifth generation system (5GS) Slice admission for the AIML operations using the NSACF, will allow WTRUs who want to actively use the AIML application when the capacity of the AIML slice is reached, to allow for a better AIML application performance. Additionally, in the case that multiple AIML applications that are served by different Application Server Providers (ASPs) are sharing the same slice, when the number of WTRUs registered for the slice is reached and there are WTRUs, e.g., WTRU 216, who are not active in the AIML slice, a WTRU, e.g., WTRU 220, wanting to use the slice and participate in the AIML application, may utilize embodiments for enhanced slice admission disclosed herein. In some embodiments, the NSACF is configured, for example through a prior agreement between the Application Service Provider (ASP) and the network operator, with a maximum number of WTRU registrations for the slice and/or a maximum number of PDU Sessions available to be established within the slice. When this capacity is reached, the NSAC cannot admit more WTRUs or accept new PDU Sessions for the slice.

In some example embodiments, the NSACF determines which WTRUs are eligible to be deregistered, and confirms that within the network (e.g., the policy control function (PCF) and other functions), but also with the Application Function (AF). In this sense, the AF confirms which WTRUs are allowed to be deregistered.

In other example embodiments, an estimation is made/obtained, before the slice reaches its limit (in terms of max number of WTRU registrations or PDU Sessions established), which may be used to determine that the WTRU registration/PDU Session capacity limit of the slice may occur in the near future. This determination may be based on a threshold that is fixed (less than the absolute limit). In one example, the NSACF can use analytics from a network data analytics function (NWDAF), which are related to network slice capacity to make such a determination. The analytics themselves may rely on input data such as the network functions resources or slice load. After this determination takes place, the NSAC also determines eligible WTRU(s) to be deregistered, and confirms whether WTRUs eligible for deregistration are allowed for deregistration, with the other network functions, and the Application Function.

Instead of, or in addition to, AIML network slice applications, the disclosed embodiments may be applicable to any general applications and AF requests to the NEF. There are some AIML applications such as Federated Learning, where multiple WTRUs are performing ML model training for the application. For these application, there is a prior/ongoing process of selecting which WTRUs to participate in the application (e.g., Federated Learning). In this case, the application function can provide a good feedback about which WTRUs are allowed to deregister. In general, the solutions described may apply to other applications, especially if the application function may provide a relevant feedback about the WTRUs to be deregistered from the slice. The benefit for the AF is for a better utilization and control provided by the 5G system (5GS) for which WTRUs may access or maintain access to a slice reaching WTRU capacity.

Embodiments for WTRU deregistration from a network slice with AIML capabilities will be described separately, in context of single slice dedicated to AIML operation and later, as a slice with AIML functions provided by multiple application service providers (ASPs).

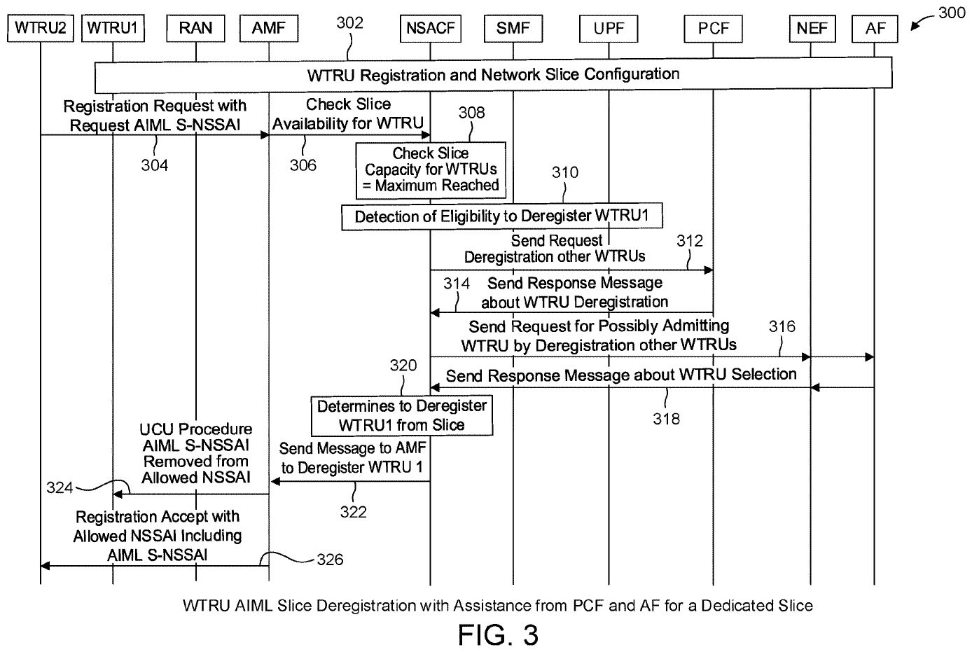

Embodiments for single slice dedicated to an AIML application. In reference to FIG. 3, a method 300 is disclosed for a case where a WTRU2 wants to use the AIML slice, the 5G Core (5GC) checks that the maximum number of WTRUs registered for the slice is reached, and how the 5GC requests Application Function (AF) assistance to deregister WTRU1, which is already registered in the slice, after certain conditions are verified, to be able to admit WTRU2 into the slice.

The method 300 of FIG. 3 is shown and described for a single slice dedicated to a single AIML application, although this procedure can also be extended to WTRUs using multiple AIML applications in the same slice, where the AIML applications are handled by the same application service provider.

As mentioned previously, for example, upon AF request, the 5G Network may negotiate with the AF for related policy setting and network slice configuration for the application requested by the AF. For example, when a WTRU enrolled for a federated learning (FL) operation, the WTRU may be configured with the network slice information for exchanging traffic for the FL operation.

In the example method 300 of FIG. 3, at step 302, WTRU1 is registered for use of the AIML application in the slice with the application server. A new WTRU2, which is not using the application, wants to use the AIML application, using this network slice. In step 304, the WTRU2 sends a registration request to the 5GS, particularly to the AMF via the RAN. In one embodiment, this registration request includes the AIML slice (S-NSSAI) as a part of the requested NSSAI.

In step 306, the AMF sends a message to the NSACF that is serving the slice, or the area the WTRU is located, to check slice availability information. For example, the AMF needs to check whether the number of WTRUs already registered in this AIML slice has reached its maximum number of WTRUs, whether and how to admit the WTRU2 to the slice. In step 308, the NSACF function checks the slice's capacity. In this example, the NSACF checks the number of WTRUs registered to the slice and compares it to the limit per slice (or per area that the NSACF serves). In the example shown, the NSACF determines 308 that the number of WTRU registrations to this slice has reached its maximum. This event triggers the 5GC functions to check if it is possible to deregister some WTRUs already registered in the slice in order to possibly admit the new WTRU2 to the slice. In step 310, the NSACF with the assistance of SMF and UPF detects whether some registered WTRUs (in the illustrated example, WTRU1) are eligible to be deregistered from the slice.

Various conditions may be used in deciding that WTRU1 is eligible to be deregistered. Example considerations include the following:
(1) WTRU1 has no active PDU sessions in this slice, e.g., even though WTRU1 is registered to the AIML slice, it does not have any active PDU session.
(2) WTRU1 has no PDU sessions in this slice, e.g., this can be further characterized by an inactivity timer that indicates how long WTRU1 has been without a PDU session in the slice, and if the WTRU1 has not had a PDU session for a duration that exceed a certain threshold, it becomes eligible for deregistration. For an AF that runs more than one application on a S-NSSAI dedicated to it, e.g., in the case of on demand S-NSSAI, the AF may provide the relative importance of certain traffic on an S-NSSAI dedicated to it, e.g., by indicating that any WTRU that runs a specific application AIML operation, may have precedence over other WTRUS running a different application from the same AF on the on-demand S-NSSAI.
(3) In another case, WTRU1 may have an active PDU session with the slice, but WTRU1 has no active AIML traffic being exchanged with the AF and PDUs are routed via the user plane function (UPF). In this case, for example, the NSACF may use an inactivity timer to indicate how long WTRU1 has not been exchanging AIML traffic in this slice, and if WTRU1 has stayed inactive for a time greater than a certain threshold, then WTRU1 may be eligible to be deregistered. If one or more of the foregoing conditions are valid, WTRU1 becomes eligible to be deregistered from the AIML slice in effort to admit WTRU2 to the AIML slice.

In step 312, the NSACF may send a request to the PCF if there are policies regarding WTRU deregistration or other parameters. For example, there may be several WTRUs which are not active in the slice, and the NSACF checks with the PCF which of the inactive WTRUs may be considered for deregistration based on network policies. At step 314, the PCF may provide its determination/assistance information to the NSACF regarding WTRU1 deregistration. At step 316 of FIG. 3, the 5GC may further check with the application function whether a change in the configuration of WTRUs for the considered AIML application is permitted/plausible / desired.

In method 300 shown, the NSACF may send a message to the AF, via the network exposure function (NEF), to request AF assistance regarding deregistering WTRU1 and admitting WTRU2. In one embodiment, the message indicates a slice capacity reached condition and identifiers of WTRUs subject to access control decision (e.g., WTRU2 and one or more candidate WTRUs, such as WTRU1, identified for AIML slice de-registration). The application function generally may have knowledge regarding WTRU1 application usage, and WTRU1 likely future usage, and WTRU2 potential AIML application usage. The AF can also have information about a certain priority that exists between WTRU1 and WTRU2 regarding the AIML application and traffic. In step 318, the application function might confirm that it authorizes and agrees that WTRU1 may be deregistered from the AIML slice (at least for the time being), to allow WTRU2 to be admitted for slice registration and usage.

In the case of WTRU2 using a different AIML application (i.e., identified with application ID2) and WTRU1 was using AIML application-1 (i.e., identified by Application ID1), the application function can have knowledge about a certain priority between the differing applications (for example a Federated Learning application may have higher priority at the time of the request, than another AIML split operation). This knowledge may further assist the AF in authorizing the change of configuration of WTRU1 and WTRU2 in slice registrations.

In one example, at step 318, the application function may forward its response to the NEF and the NEF forwards this message to the NSACF. In this message, the application function may provide some assistance information (e.g., further usage information) and a permission to deregister WTRU1 and admit WTRU2 for the slice.

In step 320, having received confirmation from the application function, the NSACF authorizes the information from the AF and determines that WTRU1 is to be deregistered form the network slice. At this point, the NSACF might optionally recheck the slice capacity to make sure the capacity is still maximized. The NSACF may send a notification or acknowledgment (not shown) to the AF to confirm the de/registration to the AIML slice for WTRU1 and WTRU2.

As shown by step 322, the NSACF sends a request to deregister WTRU1 from the slice to the serving AMF. Once this request is authorized by the AMF, the AMF may initiate 324 deregistration of WTRU1 from the slice. Once WTRU1 is deregistered, WTRU2 may be registered.

In step 324, the AMF may perform a WTRU Configuration Update procedure (UCU) with WTRU1, and processes slicing information, i.e., Allowed NSSAI, with the AIML slice S-NSSAI remove/not included). In this manner, WTRU1 is configured/knows that the S-NSSAI for this AIML slice is not allowed to be used for the moment. At step 326, the AMF sends a registration accept message to the WTRU2 including slice information, e.g., allowed NSSAI including the S-NSSAI of this AIML slice so WTRU2 can establish a PDU session for the AIML application in this slice and start exchanging traffic.

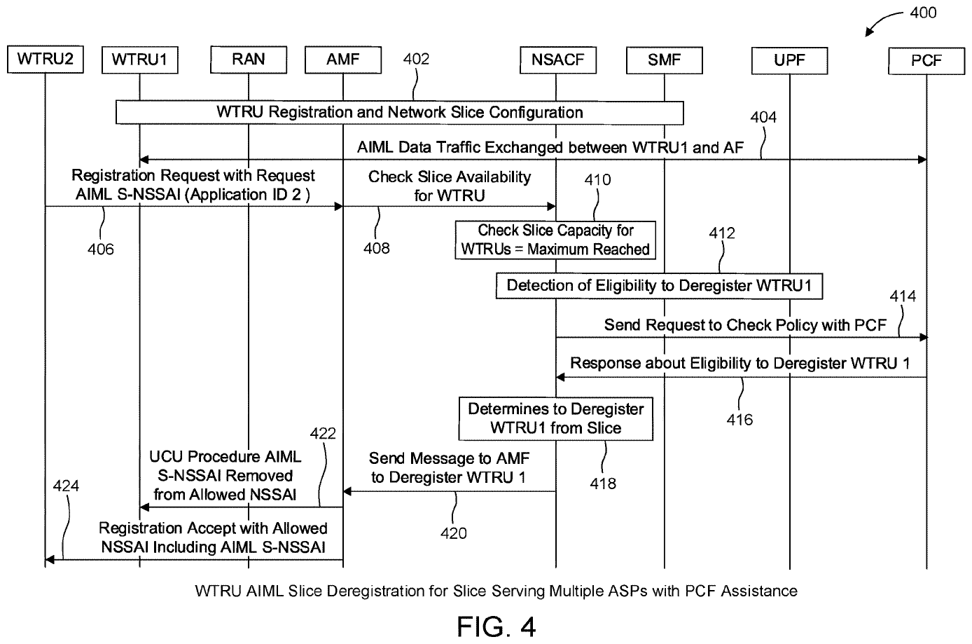

Turning to FIG. 4, an example method 400 for slice admission control of a slice supporting multiple AIML applications from different providers is shown. In these embodiments, the AIML slice of interest is supporting multiple applications that are hosted by different service providers. In method 400, WTRU1 was registered 402 and given slice access similarly as discussed in previous embodiments. As shown in step 404, WTRU1 has been exchanging AIML traffic pertaining to an application-1 with application ID1 provided by application service provider ASP1 (not separately shown), and WTRU2 is interested to use the AIML slice to exchange AIML traffic pertaining to application-2 with identifier Application ID2 and provided by ASP2. In this scenario, it is assumed that two service providers have pre-agreed with the 5GS regarding a slice usage policy for the AIML traffic. For example, the 5GS might have stored policies in the PCF for example, that the application-1 can use a certain percentage of the slice (for example 80%) while the ASP2 is able to use another percentage of the slice (for example 20%). These percentage might be different depending on whether the two applications are simultaneously using the slice and might change depending on whether the slice has reached the maximum number of registered WTRUs/PDU sessions or not.

In FIG. 4, step 402, upon AF request, the 5G network may negotiate with the AF for related policy settings and network slice (NS) configuration for the application requested by AF. For example, when WTRU1 is enrolled for a FL operation, WTRU1 may be configured on the network slice for exchanging traffic for the FL operation. In step 404, WTRU1 is exchanging data traffic with an AIML application provided by the application server, e.g., for AIML application-1, provided by ASP1.

In step 406, new WTRU2 wants to use the AIML slice to exchange AIML traffic for application-2 provided by ASP2. The WTRU2 sends a registration request to the 5GS, particularly to the AMF, via the RAN. WTRU2 includes the AIML slice S-NSSAI in the request S-NSSAIs in this message. WTRU2 may also include the application ID2 in this message or the ASP ID2, to indicate that it wants to register for this slice to exchange traffic pertaining to application2 provided by ASP2.

In step 408, the AMF sends a message to the NSACF that is serving the slice, or the area the WTRU is located, to check slice availability information, e.g., to check whether the number of WTRU registrations has reached its maximum. In step 410, the NSACF function checks if the number of WTRUs registered to the slice reaches the limit per slice (or per area that the NSACF serves). When the NSACF determines that the number of WTRU registrations to this slice has reached its maximum, it triggers the 5GC functions to check if it is possible, referred to as eligible and allowed, to deregister any WTRUs already registered in the slice to be able to admit the new WTRU2 to the slice.

In step 412 of FIG. 4, the NSACF, with the assistance of a session management function (SMF) and user plane function (UPF), detects whether some registered WTRUs (in the illustrated example WTRU1) are eligible to be deregistered from the slice. Certain conditions may be considered when deciding that WTRU1 may be deregistered similar to those of previously-mentioned embodiments. These conditions may be, for example, WTRU1 has no active PDU sessions in this slice. WTRU1 might have a PDU session with the slice, but WTRU1 may have no active AIML traffic that is being exchanged between WTRU1 and AF and routed via the UPF. This may be evaluated by an inactivity time threshold for WTRU1. The inactivity time threshold can vary for each WTRU and depend on the application and other parameters. If one or more of these conditions are valid, WTRU1 becomes eligible to be deregistered from the AIML slice in order to admit WTRU2.

Since WTRU1 was using application-1 provided by ASP1 and WTRU2 wants to use application-2 provided by ASP2, the 5GS should check the existing policies regarding slice usage between the ASP1 and ASP2 for this AIML slice. In step 414, the NSACF sends a request to the PCF to check the policy for slice usage and agreement between 5GS and the two ASPs regarding this slice. The PCF then checks the policy to assist in determining whether to deregister WTRU1 to allow WTRU2 to register. For example, if the ASP1 has been using more of its quota of WTRU registrations (before the slice has reached its maximum WTRUs), or for example 85% instead of the agreed percentage of 80%, the policy determines that WTRUs (e.g., WTRU1) using the application-1 provided by ASP1 can be deregistered to allow WTRU2 to register. In step 416, the PCF provides its determination/assistance information to the NSACF regarding WTRU1 deregistration. In step 418, the NSACF receives the assistance information from the PCF and determines to deregister WTRU1 form the AIML slice. In step 420, the NSACF sends this message/request to deregister WTRU1 from the slice to the serving AMF and once this request is authorized by the AMF, the AMF decides to deregister WTRU1 from the slice.

In step 422, the AMF may perform a WTRU Configuration Update (UCU) procedure with WTRU1, and processes slicing information, i.e., allowed NSSAI, with the AIML slice S-NSSAI removed/not included). In this manner, WTRU1 is configured to know that the S-NSSAI for this AIML slice is currently not allowed to be used.

In step 424, the AMF sends a registration accept message to the WTRU2 including slice information, e.g., allowed NSSAI including the S-NSSAI of this AIML slice.

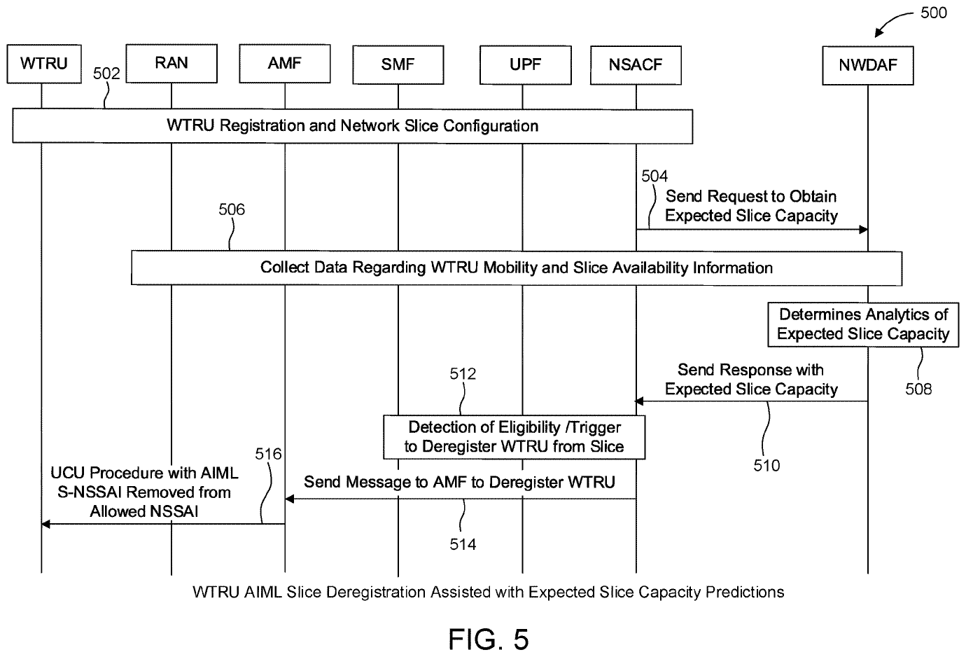

Embodiments for WTRU deregistration using slice capacity analytics, are discussed in reference to FIG. 5. The following embodiments relate to a procedure where the 5GS relies on an expected slice capacity of the AIML slice to determine whether to deregister one or more WTRUs from the slice. These embodiments may be utilized even though the slice may not have currently reached its maximum number of WTRUs.

In the previous embodiments, one of the conditions that was satisfied in order to perform WTRU slice deregistration is that the number of registered WTRUs for the slice has reached its maximum. In the following embodiments, such a condition is not required, and it is assumed that the AIML Slice capacity has not currently reached its maximum number of registered WTRUs. Using predictions from a network data analytics function (NWDAF) for example, the 5GS may decide to deregister one or more WTRUs, when expecting the slice may potentially reach a maximum capacity of WTRUs at some time in the future.

Referring to FIG. 5, a method 500 for WTRU/AIML slide deregistration with expected slice capacity predictions is shown. Per an AF request, the 5G Network may negotiate with the AF (not shown) for related policy settings and a network slice configuration for the application requested by the AF. For example, when a WTRU is enrolled for a FL operation, the WTRU may be registered/configured 502 on the network slice for exchanging traffic for the FL operation. At this point, the WTRU is exchanging AIML traffic within the serving AIML slice of interest and the capacity of the slice, in terms of maximum number of WTRUs, has not yet reached its maximum.

On occasions, for example, periodically, or when the capacity reaches a certain threshold, in step 504, the NSACF decides to request information from the NWDAF for, or a determination of, an estimate of the expected slice capacity within a certain period of time, for example, 10 minutes. The NSACF sends this request to the NWDAF. In step 506, the NWDAF collects relevant input data from different network entities, including for example, the NSACF, the AMF, RAN, UPF, SMF, as well as operations and management (OAM). This input data may include information regarding WTRU mobility, as well as slice availability and WTRU registrations, in addition to potentially including network performance parameters.

In step 508 of FIG. 5, the NWDAF uses the collected input data from the different network entities to determine analytics on the expected slice availability within the duration that the NSACF has provided. At step 510, the NWDAF provides an expected slice availability result to the NSACF. In step 512, according to the expected slice availability result, the NSACF may determine that the slice will reach its maximum within the provided period, and may implement measures to enable new WTRUs ability to continue to join the slice, for example WTRU deregistration should be performed.

Similar to the previous embodiments, various conditions may be used to assist the NSACF in determining that a WTRU is eligible to be deregistered from the AIML slice. Some conditions to consider when deciding that one or more WTRUs may be deregistered include: a registered WTRU has no active PDU sessions in this slice; or that the WTRU may have a PDU session with the slice, but has no active AIML traffic that is being exchanged with AF and the PDU session can be routed via the UPF. An inactivity time threshold may be utilized for evaluating whether a condition is met and the inactivity time threshold can vary for each WTRU and/or depend on the specific application and/or other parameters.

In step 514, the NSACF sends a message/request to deregister a WTRU meeting the deregistration conditions from the slice to the serving AMF. Once this request is authorized by the AMF, the AMF decides to deregister WTRU1 from the slice. In step 516, the AMF performs a WTRU Configuration Update (UCU) procedure with the WTRU being deregistered, and processes related slicing information (i.e., allowed NSSAI, with the AIML slice S-NSSAI remove/not included for the deregistered WTRU). This way, the deregistered WTRU is configured to know that the S-NSSAI for this AIML slice is currently not allowed to be used.

An example NSACF for this embodiment may be configured to perform the following functions. Initially, the NSACF determines to check the slice capacity and finds that it has not reached the maximum number of WTRUs but has reached a certain threshold. The NSACF sends a request to an NWDAF to obtain expected slice capacity in a future time window and receives a message from the NWDAF with predictions about slice capacity in the proposed window of time. After foreseeing from the result received for the NWDAF that the slice might reach capacity in terms of WTRU slice registrations, the NSACF may determine if one or more WTRUs are eligible to be deregistered from the AILM slice even though capacity has not yet been reached. Once a WTRU has been determined eligible for deregistration, the NSACF may send a message to the AMF to request deregistration of WTRU. In this manner, a network slice admission control function may be utilized to improve slice utilization and efficiencies.

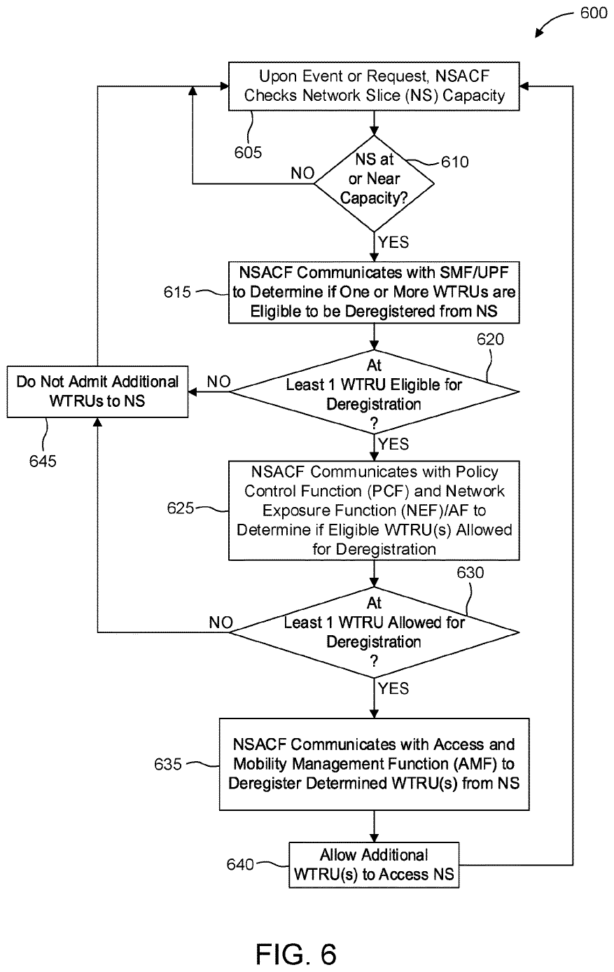

Referring to FIG. 6, an example method 600 for a network node having a network slice admission control function (NSACF) is shown. Method 600 may begin with the NSACF checking 605 network slice (NS) capacity, which may be initiated upon occurrence of an event, such as a new WTRU requesting slice admission to an AMF, a periodic schedule or expiration of a timer, an internal threshold of WTRUs registered for the NS being reached or exceeded, an indication of one or more network performance parameters or other factor that may benefit from determining a threshold of NS capacity may be reached or exceeded. If 610, the NS is at or near a threshold of capacity, the NSACF next communicates 615 with other functions such as the SMF and UPF to determine if one or more WTRUs registered with the NS may be eligible to be deregistered, e.g., if any WTRUs do not have an active PDU session or active AIML PDUs, similar to previously-described embodiments. If 620, at least one WTRU is determined eligible for potential slice deregistration, the NSACF communicates with the PCF, and the AF, via the NEF, to determine 625 whether any of the eligible WTRUs are allowed to be deregistered from the NS. Determination 625 may be made based on any of the factors previously discussed, such as AF permission.

Although not shown in method 600 of FIG. 6, at this point or any other point, the NSACF might recheck the slice capacity to make sure the capacity is still maximized. If 630, at least one eligible WTRU is determined allowed for deregistration (e.g., the AF confirms the eligible WTRU may be deregistered, the NSACF will communicate 635 with the AMF to deregister one or more of the determined WTRU(s) from the network slice. The NSACF may then allow 640 additional WTRU(s) to register for the NS. In one example, a number of allowed WTRU(s) may be the same as the number of deregistered WTRUs. If 620, there are no eligible WTRUs for deregistration or if 630, there are no WTRUs determined to be deregistered, the NSACF may not allow 645 additional WTRUs to be admitted to the NS.

In one example, the network node may include a processor and memory storing executable instructions for performing functions of the NSACF. The network node may further include a communication interface such as a transceiver for communicating to various other functions/nodes based on NSACF functions. As used herein, a “communication interface” may be simply a communication path or bus facilitating communications with other co-located functions in the network node and/or a physical transmitter and receiver, wired or wireless, to facilitate communications with other network nodes having non-collocated functions which may be consulted by the NSACF in the above-described embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a network node including a slice admission control function (NSACF), the method comprising:
determining whether an artificial intelligence machine learning (AIML) network slice is at a threshold of capacity for registered wireless transmit receive units (WTRUs);
based on the threshold being met, determining to deregister at least one WTRU registered to use the AIML network slice; and
sending a message, to an access and mobility management function (AMF), to deregister the at least one WTRU from the AIML network slice.

2. The method of claim 1, further comprising:
sending a message to the AMF enabling one or more new WTRUs to register for use of the AIML network slice.

3. The method of claim 1, wherein prior to determining to deregister the at least one WTRU, the method further comprises:
determining whether the at least one WTRU is eligible for deregistration through communication with at least one of a session management function (SMF) and user plane function (UPF) indicating an absence of packet data unit (PDU) session activity of the at least one WTRU with the AIML network slice.

4. The method of claim 1, wherein determining to deregister the at least one WTRU comprises:
sending to, and receiving from, messages with at least one of a session management function (SMF) and user plane function (UPF) to determine the at least one WTRU is eligible for deregistration based on whether an active AIML packet data unit (PDU) session with the AIML network slice has occurred within a threshold window of time; and
sending to, and receiving from, messages with at least one of a policy control function (PCF) and an application function (AF) to determine the at least one WTRU eligible for deregistration is allowed to be deregistered.

5. The method of claim 1, wherein determining to deregister the at least one WTRU comprises:
sending to, and receiving from, messages with at least one of a session management function (SMF) and user plane function (UPF) to determine the at least one WTRU is eligible for deregistration based on whether any packet data unit (PDU) session with the AIML network slice has occurred within a threshold window of time; and
sending to, and receiving from, messages with at least one of a policy control function (PCF) and an application function (AF) to determine the at least one WTRU eligible for deregistration is allowed to be deregistered.

6. The method of claim 1, wherein the threshold of capacity comprises a maximum capacity of registered WTRUs for the AIML network slice.

7. The method of claim 1, wherein the threshold of capacity comprises an estimated capacity of registered WTRUs less than a maximum capacity.

8. The method of claim 7, wherein the estimated capacity is determined by polling a network data analytics function (NWDAF).

9. A network node comprising:
a communication interface and a processor coupled to a memory storing instructions, that when executed by the processor, perform a slice admission control function (NSACF) configured to cause the processor and communication interface to:
determine whether an artificial intelligence machine learning (AIML) network slice is at a threshold of capacity for registered wireless transmit receive units (WTRUs);
based on the threshold being met, determine to deregister at least one WTRU registered to use the AIML network slice; and
send a message, to an access and mobility management function (AMF), to deregister the at least one WTRU from the AIML network slice.

10. The network node of claim 9, wherein the NSCAF is further configured to cause the processor and transceiver to:
send a message to the AMF enabling one or more new WTRUs to register for use of the AIML network slice.

11. The network node of claim 9, wherein the NSCAF is further configured to cause the processor and communication interface to:
prior to determining to deregister the at least one WTRU, determine whether the at least one WTRU is eligible for deregistration through communication with at least one of a session management function (SMF) and user plane function (UPF) indicating an absence of packet data unit (PDU) session activity of the at least one WTRU with the AIML network slice.

12. The network node of claim 9, wherein in the determination to deregister the at least one WTRU, the NSCAF is further configured to cause the processor and communication interface to:
send to, and receive from, messages with at least one of a session management function (SMF) and user plane function (UPF) to determine the at least one WTRU is eligible for deregistration based on whether an active AIML packet data unit (PDU) session with the AIML network slice has occurred within a threshold window of time; and
send to, and receive from, messages with at least one of a policy control function (PCF) and an application function (AF) to determine the at least one WTRU eligible for deregistration is allowed to be deregistered.

13. The network node of claim 9, wherein in the determination to deregister the at least one WTRU, the NSCAF is further configured to cause the processor and communication interface to:
send to, and receive from, messages with at least one of a session management function (SMF) and user plane function (UPF) to determine the at least one WTRU is eligible for deregistration based on whether any packet data unit (PDU) session with the AIML network slice has occurred within a threshold window of time; and
send to, and receive from, messages with at least one of a policy control function (PCF) and an application function (AF) to determine the at least one WTRU eligible for deregistration is allowed to be deregistered.

14. The network node of claim 9, wherein the threshold of capacity comprises a maximum capacity of registered WTRUs for the AIML network slice.

15. The network node of claim 9, wherein the threshold of capacity comprises an estimated capacity of registered WTRUs less than a maximum capacity.

16. The network node of claim 15, wherein the estimated capacity is determined by the NSCAF further configured to cause the processor and communication interface to:
poll a network data analytics function (NWDAF) for the estimated capacity.
